(19) United States
(12) Patent Application Publication
(10) Pub. No.: US 2010/0021275 A1
(43) Pub. Date: Jan. 28, 2010

(54) DUAL CYLINDER CART

(76) Inventor: George W. Ratermann, Livermore, CA (US)

Correspondence Address: SCHNECK & SCHNECK, P.O. BOX 2-E, SAN JOSE, CA, 95109-0005, US

(21) Appl. No.: 12/179,431

(22) Filed: Jul. 24, 2008

(51) Int. Cl. B62B 1/06

(52) U.S. Cl. 414/454

(57) ABSTRACT

A hand cart useful in transporting one or two cylinders for example of the type used to contain compressed gasses. A preferred embodiment has at least one pair of cylinder-grasping arms rotatable apart to a spread open position for loading and unloading cylinders, and rotatable together to a closed position for holding cylinders. A fold-out prop helps support the cart and tanks so that vertical force is not needed to move the cart forward or backward, and stabilizes the cart while stationary.

### TECHNICAL FIELD

The present invention relates generally to hand trucks and carts, and more specifically to carts for transporting two gas cylinders.

### BACKGROUND

U.S. Pat. No. 5,340,136 for “Cylinder Cart with Magnetics” by MacNeil et al. uses magnetic plates to hold two cylinders in place, and uses a foot-pedal actuated cam arrangement to separate the cylinders from the magnets when they are to be removed from the cart. U.S. Pat. No. 6,224,071 for “Three Wheeled Cart for Gas Cylinders” by Dummer uses a chain to hold two cylinders in place. U.S. Pat. No. 5,445,399 for “Retractable Hand Truck having Positive Leg Lock” by Salvucci, Sr. is a three legged cart which relies on gravity to hold one cylinder in place.

Other patents for two-tank carts include: U.S. Pat. No. D 423,173 for “Double Cylinder Dolly” by Horner et al.; U.S. Pat. No. 5,431,422 for “Tank Truck” by Gamache; U.S. Pat. No. 6,116,623 for “Dual Cylinder Cart with Firewall Divider” by Salvucci; and U.S. Pat. No. 7,273,216 for “Welding Tank Cart System” by Hohrman.

However, none of the above carts includes both a convenient and effective way to secure gas cylinders or tanks.

### SUMMARY

The present invention provides a hand cart which is useful in transporting one or two gas cylinders for example of the type widely used to contain compressed gasses for welding. A preferred embodiment has cylinder-securing means and a fold-out support assembly or prop to help support the cart and tanks so that vertical force is not needed to move the cart forward or backward, and to stabilize the cart while stationary.

One embodiment features an elongated frame having a bottom end with wheels and a top end with handles; and at least one pair of cylinder-grasping arms pivotally mounted to the frame and rotatable, on axes parallel to axes of the cylinders, apart to a spread open position for loading and unloading cylinders, and together to a closed position for holding cylinders. The embodiment also includes a prop having an upper end pivotally attached to the frame between the bottom end and the top end, and having a lower end which can swing away from the bottom end of the frame and rest on a floor surface to support the cart, and swing toward the bottom end to clear the floor surface so that the cart can be moved on the wheels.

### BRIEF DESCRIPTION OF THE DRAWINGS

FIG. 1 is a front isometric view of a dual tank cart with grasping arms closed around two cylindrical tanks according to one embodiment of the present invention.

FIG. 2 is a rear isometric view of the FIG. 1 cart.

FIG. 3 is a rear view of the FIG. 1 cart, without tanks and without a caster support assembly, showing an arm control column with a tiller handle.

FIG. 4 is a right side view of the FIG. 1 cart without tanks and with the caster support assembly folded in.

FIG. 5 is a top view of the FIG. 1 cart with grasping arms closed around one cylindrical tank.

FIG. 6 is a front isometric view of the FIG. 1 cart, without tanks, showing a flip plate floor support in its folded up position.

FIG. 7 is a detail of the FIG. 6 cart showing the flip plate floor support in its folded down position.

FIG. 8 is a detail view of a caster support assembly showing a lock mechanism and foot pedal release.

FIG. 9 is a detail view of the FIG. 2 cart showing a parking brake.

FIG. 10 is a rear view of a first alternate embodiment having an arm control column operated by a vertically sliding foot pedal.

FIG. 11 is a rear view of a second alternate embodiment having an arm control column operated by a rocking foot pedal.

FIG. 12 is a rear view of a third alternate embodiment having a pull down handle controlling three grasping arms.

FIG. 13 is a rear view of a fourth alternate embodiment in which the cylinder securing means includes collar flaps controlled by a vertical ratchet track.

FIG. 14 is a detail view of the FIG. 13 embodiment showing collar flaps in place around the necks of two cylinders and showing, in phantom, the collar flaps folded back from the cylinder necks.

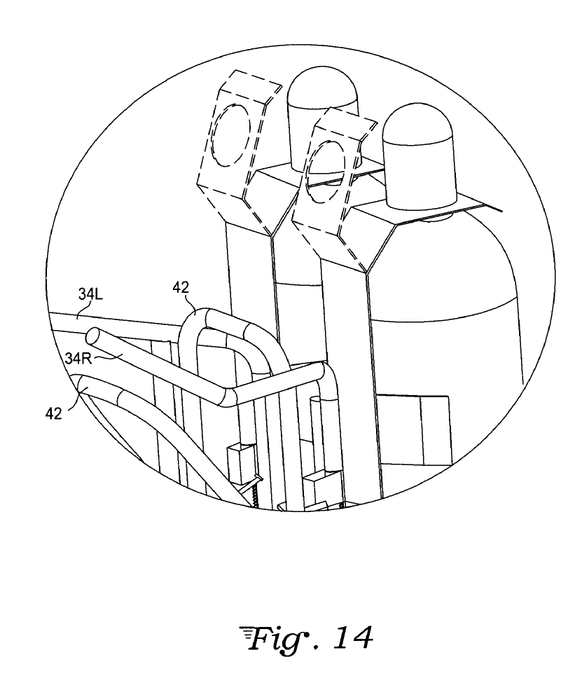

### DETAILED DESCRIPTION

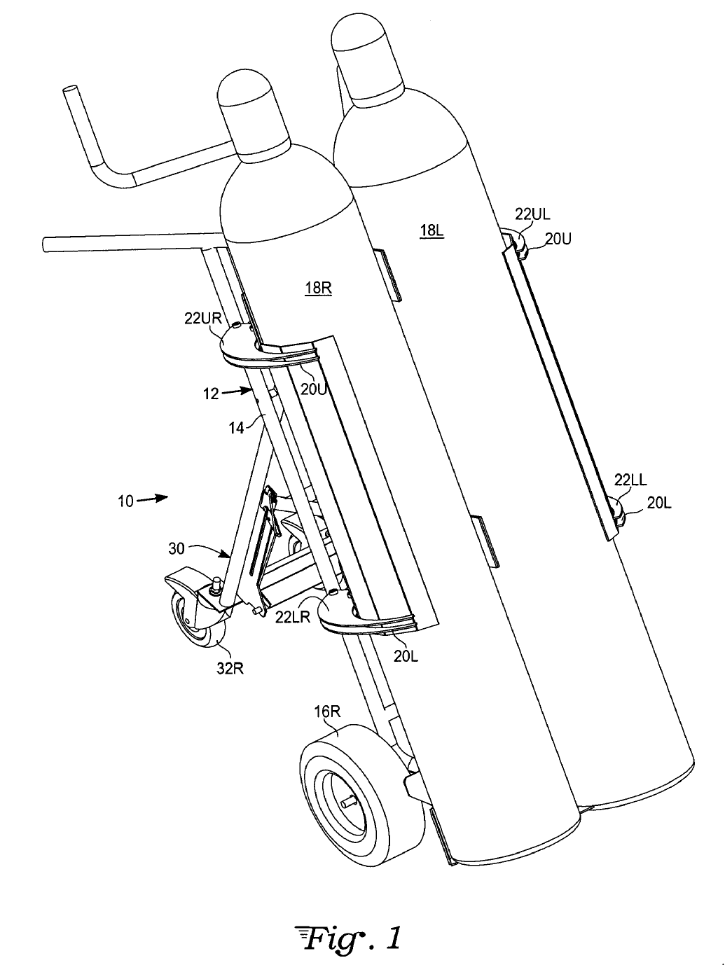

With reference to FIG. 1, cart 10 is formed by an elongated frame 12 including vertical members 14 (only one of which is visible) mounted on wheels 16 (only right wheel 16R is visible) holding two cylinders 18L, 18R in upper and lower pairs 20U, 20L of cylinder-grasping arms 22UL, 22UR, 22LL, 22LR in their closed position for transporting the cylinders. The arm pairs 20 are rotatable to a spread open position (not shown) for loading and unloading cylinders 16. FIG. 1 also shows part of an articulated support (also referred to as a caster assembly or prop) 30 having wheels 32 (only right wheel 32R is visible) which swings out to rest on a floor and help stabilize cart 10 while parked or, if desired, while moving.

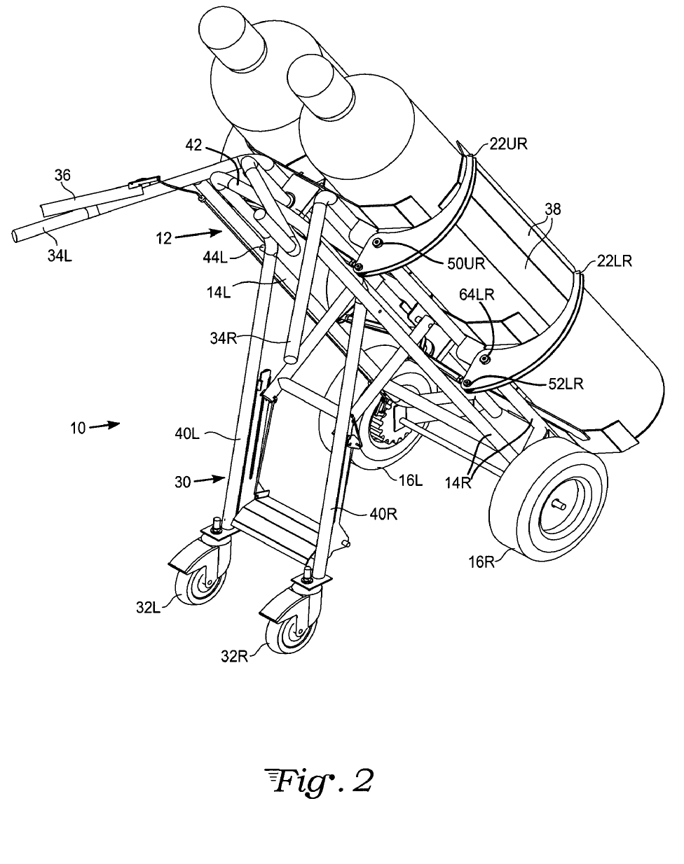

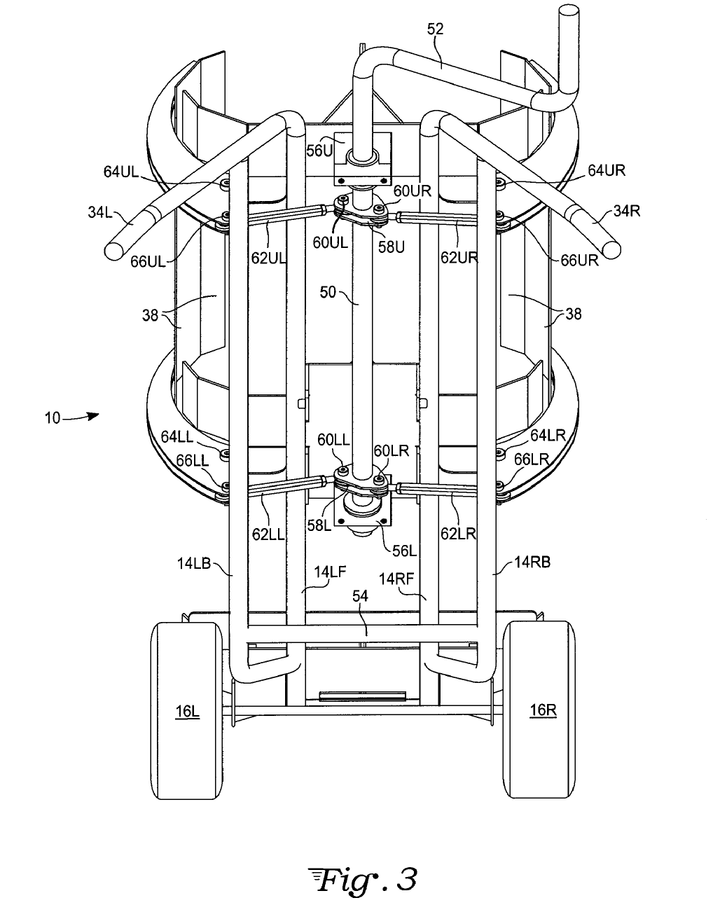

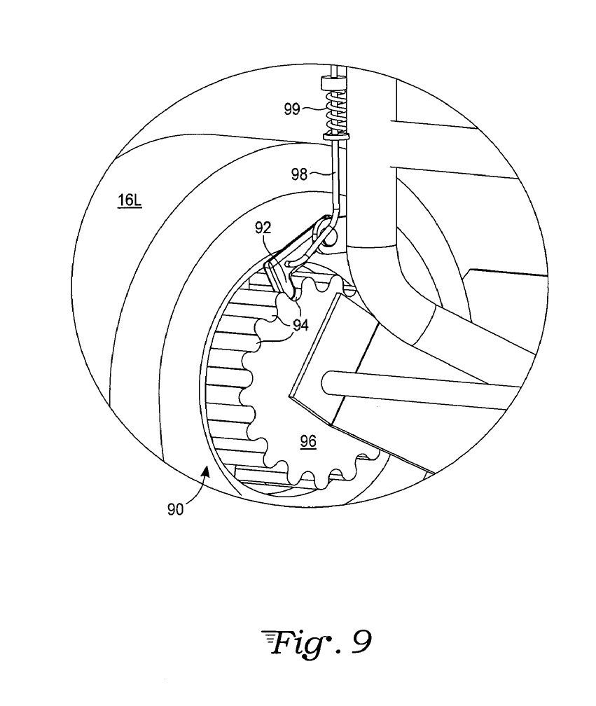

In FIG. 2, the cart 10 has frame 12 formed by spaced apart parallel elongated vertical members 14L and 14R, on the bottom ends of which are wheels 16L and 16R. At their top ends vertical members 14L and 14R have rearward extending handles 34L and 34R, which may be straight as shown in FIGS. 1 and 2 or curved as shown in FIGS. 3-6. Hand levers 36 (only a left lever shown) operate a wheel lock as discussed with reference to FIG. 9 below. The cylinder-securing means preferably includes vertical slats 38 between the upper and lower cylinder-grasping arms.

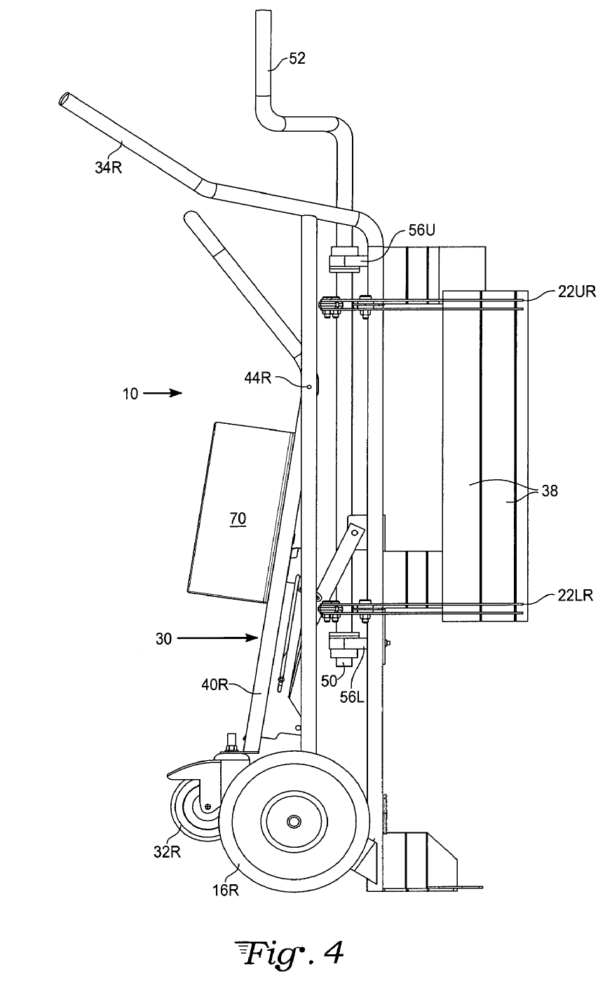

The caster support assembly 30 preferably includes parallel legs 40L, 40R having caster wheels 32L, 32R restable on a floor, and an upper end, with a cross-bar 42, pivotally attached by pins 44L, 44R (see also FIG. 4) to rotate relative to frame 12 between an open position as shown where the lower end of the support 30 is spaced from the frame 12 so that the cart 10 can be rolled on all four wheels 16L, 16R, 32L, 32R, or to keep the cart upright while parked, and a closed position (FIG. 4) where the lower end of the support is close to the frame so that the cart can be rolled on the main wheels 16L, 1GR.

In FIG. 3, cart 10 (with the tanks and caster support assembly removed for clarity's sake) has an arm control means embodied as an arm control column 50 and a rotating tiller handle 52. In this embodiment the left and right vertical members each have a front section (14LF, 14RF) and a back section (14LB, 14RB). Left and right back vertical sections 14LB and 14RB are preferably connected by a cross-member 54. The arm control column 50 is preferably positioned between the left and right vertical members 14L, 14R and is attached by upper and lower brackets 56U, 56L to be rotatable. Control column 50 is attached to upper and lower cams or steering cranks 58U, 58L which have right and left attachment points 60UL, 60UR, 660LL, 660LR connected to respective tie or push rods 62UL, 62UR, 62LL, 62LR.

Cylinder-grasping arms 22UL, 22UR, 22LL, 22LR have pivot joints 64UL, 64UR, 64LL, 64LR attaching them to adjacent vertical sections 14LF and 14RF. Grasping arms 22UL, 22UR, 22LL, 22LR also have radially spaced attachment points 66UL, 66UR, 66LL, 66LR where tie rods 62UL, 62UR, 62LL, 62LR apply lateral force to rotate the arms around the pivot joints between an open position (not shown) for loading cylinders 18 onto the cart 10 and a closed position (as shown) for transporting cylinders in the cart. The steering crank cams 58U, 58L are configured to stop just “over center,” to apply maximum grasping force on the cylinders.

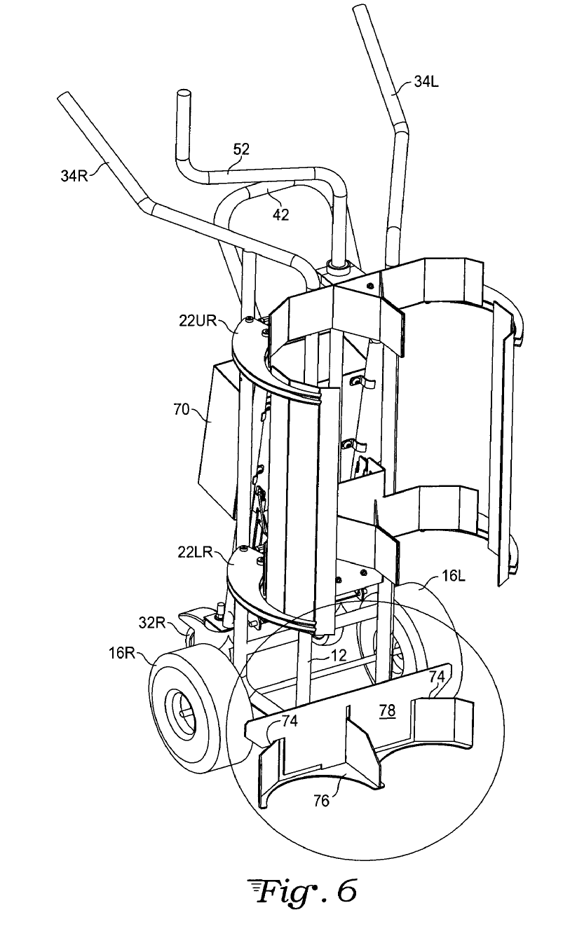

In FIG. 4, cart 10 has the caster support prop 30 in its closed position, and a utility box 70 (shown also in FIG. 6) for storing miscellaneous items, mounted on the support prop 30. From the hinge 44 point of the prop to the bottom of its wheels 32 is less distance than to the bottom of the frame wheels 16, so the prop wheels 32 do not touch the ground when the prop 30 is closed.

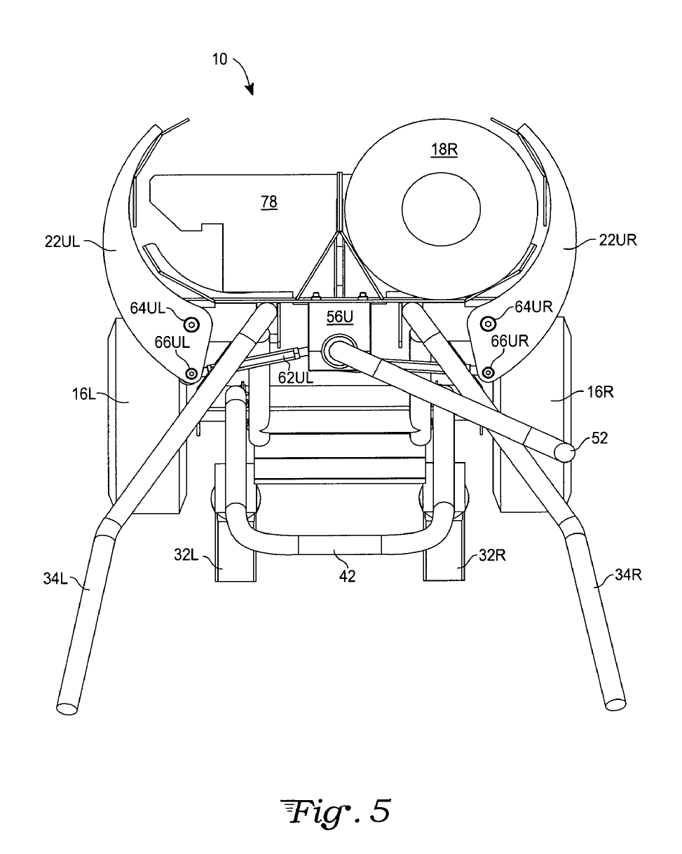

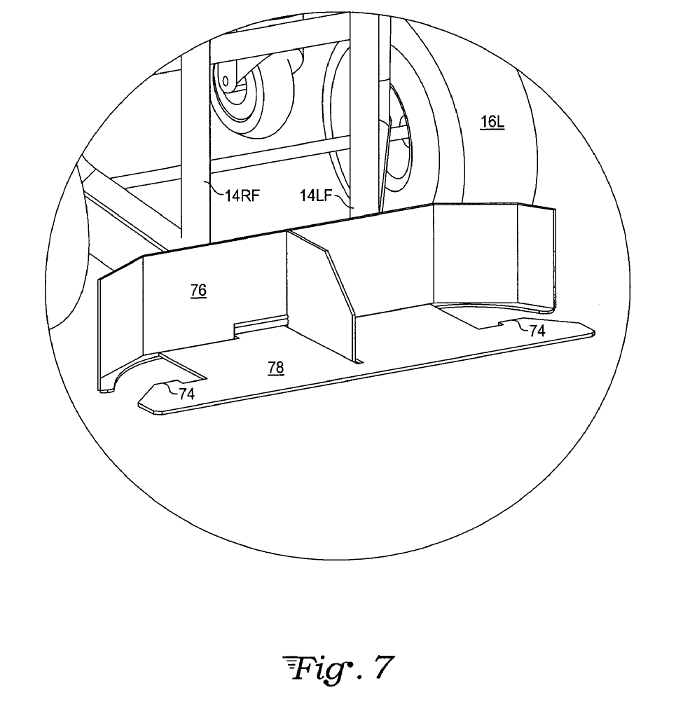

In FIG. 5, cart 10 has grasping arms 22 opened and one cylindrical tank 18R in the bottom support bracket (detailed in FIG. 7 below).

In FIG. 6, cart 10 has a bottom support bracket 76 connected to the bottom of the frame 12 and a flip plate 78 in its folded up position. Bottom support bracket 76 is shaped to fit under the edges of cylinders 18 (not shown) so that the cylinders can be lifted without supporting their entire foot surface. The flip plate 78 is held upright until lifted slightly to clear the tabs 74 on each side. Then it can lay flat.

In FIG. 7, cart 10 has the flip plate 78 in its folded down, substantially horizontal, position for supporting cylinders. Flip plate 78 can be used when transporting smaller bottles or odd sized objects.

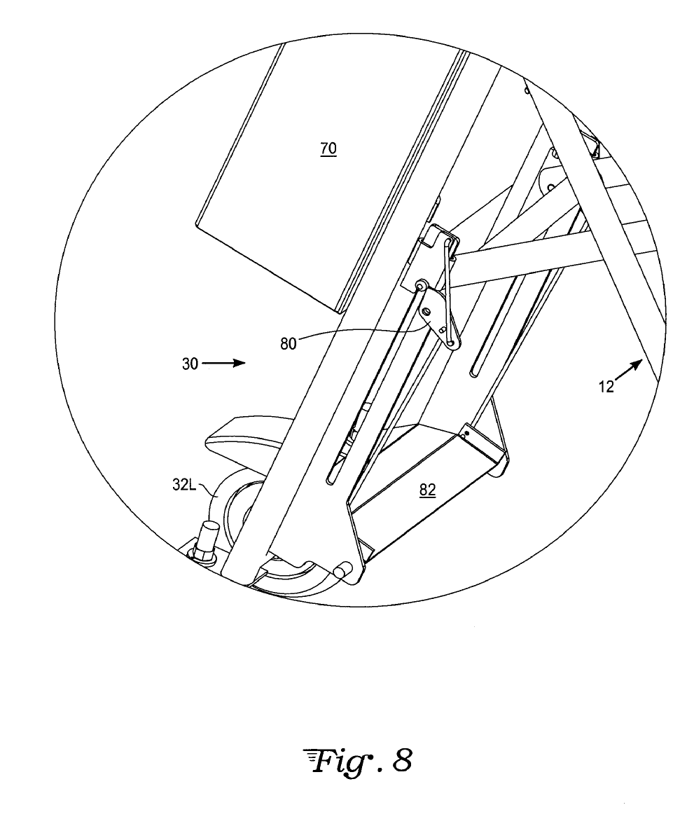

In FIG. 8, the close-up of a caster support prop 30 shows lock mechanism 80, and foot pedal lock (release) mechanism 82. The prop 30 is locked in its open position where the lower end is spaced from the frame 12 to help hold the cart 10 upright. Pressing on foot pedal 82 pulls down the lever of mechanism 80 and releases the lock, allowing the prop 30 to be folded into its closed position.

In the detail of FIG. 9, an optional but preferred hand operated wheel lock 90 (only the left of which is shown, for clarity) is formed by a locking tab 92 which engages and cooperates with notches 94 in a plate 96 on the inside of each wheel 16. The locking tab 92 is disengaged by pressing hand lever 36 (FIG. 2) downward to raise pull-rod 98. A spring 99 holds the locking tab 92 in its locked position when the hand lever 36 is released.

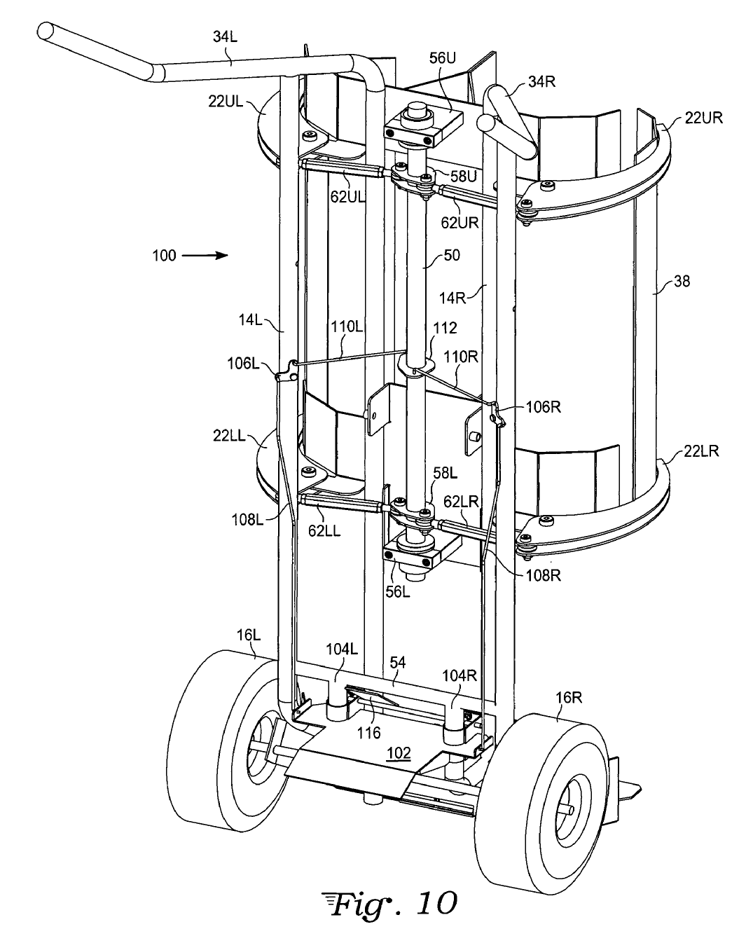

In FIG. 10, first alternate embodiment 100 of a dual tank cart has an arm control column 50 similar to the arm control column of FIG. 3 except, instead of a tiller handle, the column 50 in this embodiment 100 is turned by a vertically sliding foot pedal 102 which slides on vertical guides 104L, 104R connected to cross bar 54. Bell cranks 106L, 106R are pivotally attached to respective vertical members 14L, 14R between the foot pedal 102 and the arm control column 50. On the right and left are vertical first rods 108L, 108R, connected between the foot pedal 102 and the respective bell crank 106, and horizontal second rods 110L, 110R connected between the bell cranks 106 and a second steering crank 112 on the arm control column 50. As in embodiment 10, upper 58U and lower 58L steering cranks attached to the control column 50 have right and left attachment points connected by respective tie rods to the attachment points on respective grasping arms. Reciprocal motion of pedal 102 causes reciprocal motion of the arm control column 50, which in turn causes reciprocal motion of the cylinder-grasping arms 22. A ratchet lock mechanism (not shown) maintains tension. A release pedal 116 releases the ratchet lock.

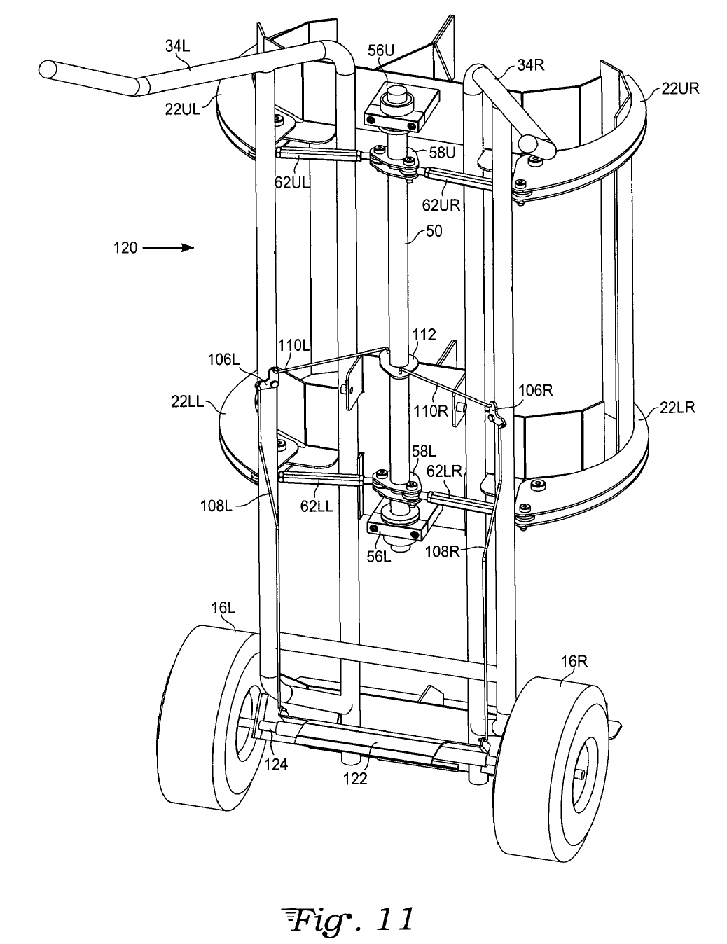

In FIG. 11, a second alternate embodiment 120 of a dual tank cart has an arm control column 50 operated by a series of pull rods 108L, 108R, 110L, 110R and bell-cranks 106L, 106R, as in first alternate embodiment 100, and having a rocking foot pedal 122 which is pivotally attached to an axel 124 between the wheels 16.

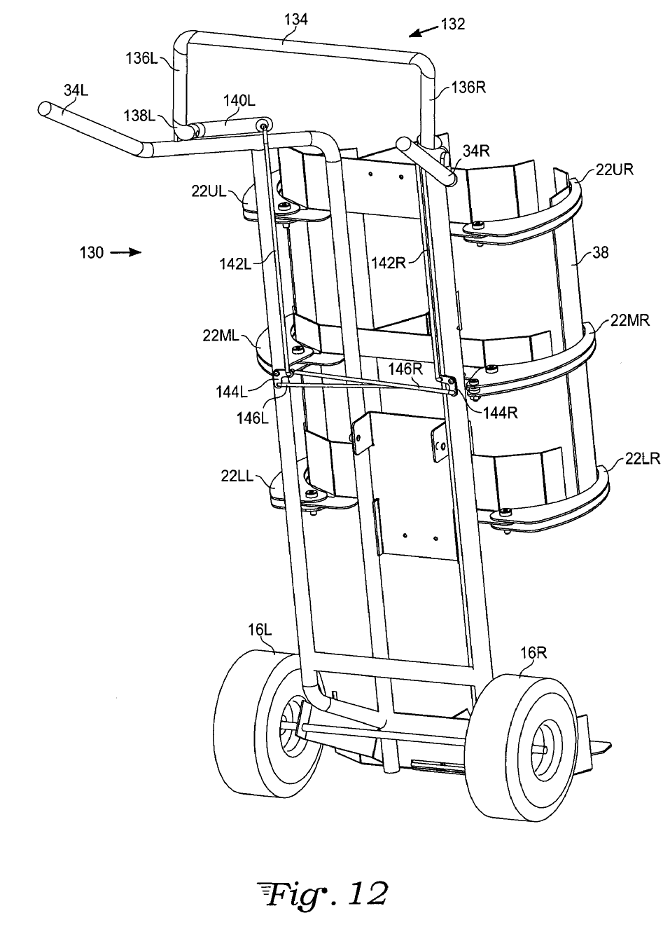

In FIG. 12, a dual tank cart is shown without tanks in a third alternate embodiment 130 having arm control means in the form of a pull down handle 132 which controls three pairs of grasping arms 22U, 22M, 22L. The pull-down handle 132 includes a horizontal transverse section 134 with, at each end, arm portions each including an upper segment 136L, 136R, an elbow segment 138L, 138R hinged to the adjacent handle member 34L, 34R, and a lower segment 140L, 140R extending at right angles from the elbow segment. The lower segments 140L, 140R are coupled by vertical rods 142L, 142R, bell cranks 144L, 144R, and horizontal rods 146L, 146R to respective middle cylinder-grasping arms 22ML, 22MR. Reciprocal motion of the pull-down handle 132 causes reciprocal motion of the cylinder-grasping arms 22U, 22M, 22L.

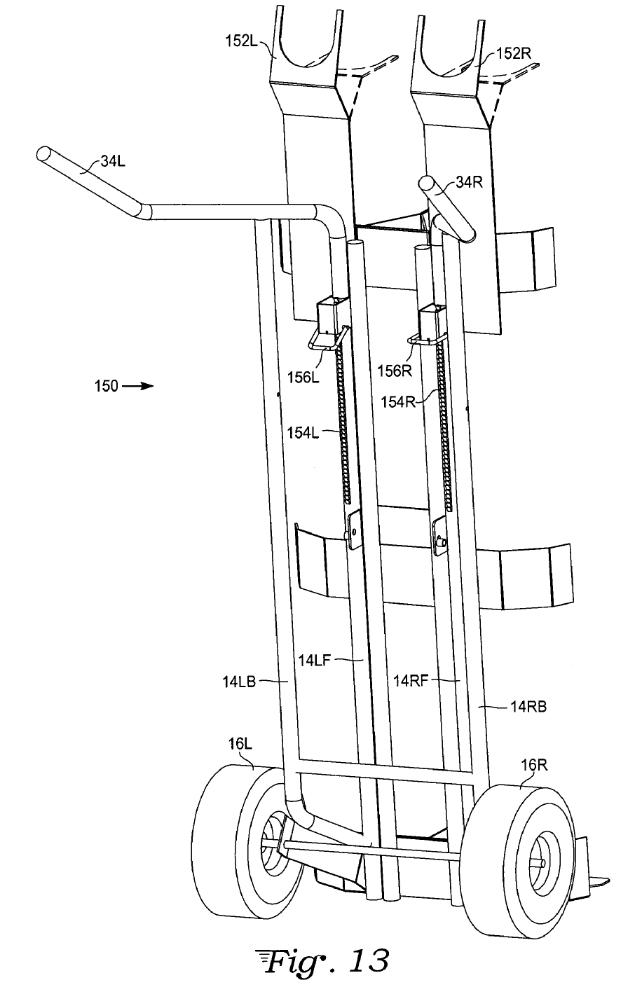

In FIG. 13, fourth alternate embodiment 150 of a dual tank cart has a cylinder securing means that includes a top holding device or collar flaps 152L, 152R which slide down over the tops of, and hold, the cylinders (not shown). The holding device is secured along vertical ratchet tracks 154L, 154R which can be released by small release levers 156L, 156R. The top holding device 152L, 152R optionally has hinges 158L, 158R that allow the flaps 152L, 152R to move away from the cylinders when not in use.

What is claimed is:

1. A cart for transporting cylinders, comprising:
an elongated frame including vertical members;
wheels connected to bottom ends of the vertical members;
handle members extending rearward from top ends of the vertical members; and
cylinder-securing means including at least one pair of cylinder-grasping arms, each arm being attached by pivot means to a respective vertical member, having an attachment point spaced radially from the pivot means, and being rotatable, around the pivot means, between an open position and a closed position; and
arm control means for moving the cylinder-grasping arms between the open position and the closed position.

2. The cart of claim 1 wherein the arm control means comprises:
an arm control column disposed between the vertical members, and rotatable around a lengthwise axis of the control column; and
a first steering crank attached to the control column and having right and left attachment points connected by respective tie rods to the attachment points on respective grasping arms whereby reciprocal motion of the column causes reciprocal motion of the cylinder-grasping arms.

3. The cart of claim 2 wherein the arm control column is connected to a tiller handle.

4. The cart of claim 2 further comprising:
a movable foot pedal attached between the wheels; and
pull rod means coupled by bell crank means between the foot pedal and the arm control column so that reciprocal motion of the pedal causes reciprocal motion of the column.

5. The cart of claim 4 wherein the pedal moves vertically.

6. The cart of claim 4 wherein the pedal reciprocates around a horizontal axel.

7. The cart of claim 4 wherein two bell crank means are pivotally attached to respective vertical members and two pull rod means each include a vertical first rod connected between the foot pedal and a bell crank and a horizontal second rod connected between the bell crank and the arm control column.

8. The cart of claim 7 wherein the horizontal second rods are connected to a second steering crank which is attached to the arm control column.

9. The cart of claim 1 wherein the arm control means comprises:
a pull-down handle including a transverse portion having laterally opposite shoulders, and arm portions at each of the shoulders having an upper segment connected to the shoulder, an elbow segment hingedly connected to the respective handle member, and a lower segment extending at an angle from the elbow segment; and
pull rod means coupled by bell crank means between each lower segment and the non-respective cylinder-grasping arm so that reciprocal motion of the pull-down handle causes reciprocal motion of the cylinder-grasping arms.

10. The cart of claim 1 wherein the cylinder-securing means comprises parallel upper and lower pairs of cylinder-grasping arms.

11. The cart of claim 10 wherein the cylinder-securing means comprises wall slats disposed between the upper and lower pairs of cylinder-grasping arms.

12. The cart of claim 1 wherein the cylinder-securing means comprises three parallel pairs of cylinder-grasping arms.

13. The cart of claim 1 further comprising:
fold-out support means including an elongated portion having a lower end (restable on a floor), and an upper end pivotally attached to the vertical members to enable the support means to be rotated so that the lower end moves between a closed position where the lower end is close to the vertical members and an open position where the lower end is spaced from the vertical members.

14. The cart of claim 13 wherein the support means comprises parallel legs connected by at least one cross-member.

15. The cart of claim 13 wherein the support means has a caster wheel on the lower end.

16. The cart of claim 13 further comprising a storage box attached to the support means.

17. The cart of claim 1 further comprising:
a flip down plate, connected to the vertical members proximate their bottom ends and extending substantially perpendicularly to the vertical members, for supporting cylinders loaded in the cart.

18. The cart of claim 1 further comprising a parking brake.

19. A cart for transporting cylinders, comprising:
an elongated frame including vertical members;
wheels connected to bottom ends of the vertical members;
handle members extending rearward from top ends of the vertical members; and
cylinder-securing means including collar flaps controlled by a vertical ratchet track.

20. A cart for transporting two cylinders, comprising:
an elongated frame having a bottom end with wheels and a top end with handles;
at least one pair of cylinder-grasping arms pivotally mounted to the frame and rotatable, on axes parallel to axes of the cylinders, apart to a spread open position for loading and unloading cylinders, and together to a closed position for holding cylinders; and
a prop having an upper end pivotally attached to the frame between the bottom end and the top end, and having a lower end which can swing away from the bottom end of the frame and rest on a floor surface to support the cart, and swing toward the bottom end to clear the floor surface so that the cart can be moved on the wheels.
